(19) United States
(12) Patent Application Publication
(10) Pub. No.: US 2025/0007121 A1
(43) Pub. Date: Jan. 2, 2025

(54) Multiple layers cylindrical cell

(71) Applicant: STOREDOT LTD., Herzeliya (IL)

(72) Inventors: Nir DOLEV, Lehavim (IL); Daniel ARONOV, Netanya (IL)

(73) Assignee: STOREDOT LTD., Herzeliya (IL)

(21) Appl. No.: 18/344,832

(22) Filed: Jun. 29, 2023

(51) Int. Cl. H01M 50/538; H01M 10/04; H01M 50/512

(52) U.S. Cl. CPC H01M 50/538; H01M 10/0422; H01M 10/0431; H01M 50/512

(57) ABSTRACT

An electrochemical cell that includes (i) a cathode tabs electrical coupler; (ii) an anode tabs electrical coupler; and (iii) a stack that is rolled about an axis, wherein the stack includes multiple instances of: (a) a cathode sheet; (b) a cathode tab that extends from the cathode sheet at a first direction; (c) an anode sheet, (e) an anode tab that extends from the anode sheet at a second direction, the second direction differs from the first direction; and (f) one or more separator sheets. Multiple cathode tabs of the multiple instances are coupled in parallel to each other by the cathode tabs electrical coupler. Multiple anode tabs of the multiple instances are coupled in parallel to each other by the anode tabs electrical coupler.

### BACKGROUND

A fast charging electrical vehicle (EV) is an electrical vehicle that can be charged at a Crate that exceeds 2 and may range between 4-10 C, 5-50 C, and the like.

There is a growing need to EV.

### SUMMARY

There may be provide a system, non-transitory computer readable medium and method for high throughput charging of fast charging electrical vehicles.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 illustrates examples of a stack;

FIG. 2 illustrates examples of a stack, a winded stack and a cross sectional view of a cylindrical cell that shows the housing of the cell, the anode tabs and the cathode tabs within the housing;

FIG. 3 illustrates examples of a stack, a winded stack and a cross sectional view of a cylindrical cell that shows the housing of the cell, the anode tabs and the cathode tabs within the housing;

FIG. 4 illustrates examples of a stack, a winded stack and a cross sectional view of a cylindrical cell that shows the housing of the cell, the anode tabs and the cathode tabs within the housing;

FIG. 5 illustrates examples of a stack, a winded stack and a cross sectional view of a cylindrical cell that shows the housing of the cell, the anode tabs and the cathode tabs within the housing;

FIG. 6 illustrates examples of a stack, a winded stack and a cross sectional view of a cylindrical cell that shows the housing of the cell, the anode tabs and the cathode tabs within the housing;

FIG. 7 illustrates examples of a stack, a winded stack and a cross sectional view of a cylindrical cell that shows the housing of the cell, the anode tabs and the cathode tabs within the housing;

FIG. 8 illustrates an example of a method; and

FIG. 9 illustrates an example of a method.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to an electrochemical cell capable of executing the method and/or to a electrochemical cell manufactured by the method.

Any reference in the specification to an electrochemical cell should be applied mutatis mutandis to a method for utilizing the electrochemical cell and/or to a method for manufacturing the electrochemical cell.

Any combination of any module or unit listed in any of the figures, any part of the specification and/or any claims may be provided.

Any combination of any steps of any method illustrated in the specification and/or drawings may be provided.

Any combination of any subject matter of any of claims may be provided.

According to an embodiment, there is provided an electrochemical cell, that includes (a) a cathode tabs electrical coupler; (b) an anode tabs electrical coupler, (c) a stack that is rolled about an axis (to provide a winded stack).

The winded stack includes multiple instances of: (i) a cathode sheet, (ii) a cathode tab that extends from the cathode sheet at a first direction, (iii) an anode sheet, (iv) an anode tab that extends from the anode sheet at a second direction, the second direction differs from the first direction; and (v) one or more separator sheets that separate anodes from cathodes.

The multiple cathode tabs of the multiple instances are coupled in parallel to each other by the cathode tabs electrical coupler.

The multiple anode tabs of the multiple instances are coupled in parallel to each other by the anode tabs electrical coupler.

According to an embodiment—the multiple cathode tabs are aligned—which simplifies the coupling of the multiple cathode tabs in parallel to each other by the anode tabs electrical coupler. The alignment also reduces the cost of the coupling of the multiple cathode tabs in parallel to each other. Furthermore—the alignment results in an accurate setting of the distance between the different cathode tabs—which contributes to the reduction of any heat differentials between different parts of the electrochemical cell.

Alignment that is made before the winding—when the cathode tabs and the cathodes are flat and parallel to each other—is easier and faster than attempting to perform the alignment when the stack is already winded.

According to an embodiment—the multiple anode tabs are aligned-which simplifies the coupling of the multiple anode tabs in parallel to each other by the anode tabs electrical coupler. The alignment also reduces the cost of the coupling of the multiple anode tabs in parallel to each other. Furthermore—the alignment results in an accurate setting of the distance between the different anode tabs-which contributes to the reduction of any heat differentials between different parts of the electrochemical cell.

Alignment that is made before the winding—when the anode tabs and the anodes are flat and parallel to each other—is easier and faster than attempting to perform the alignment when the stack is already winded.

According to an embodiment—the multiple anode tabs extend from a first side of the stack and the multiple cathode tabs extend from a second side of the stack. The first side may be opposite to the second side. Alternatively—the first side is not opposite to the second side—it may be perpendicular to the second side or be oriented at any other angle.

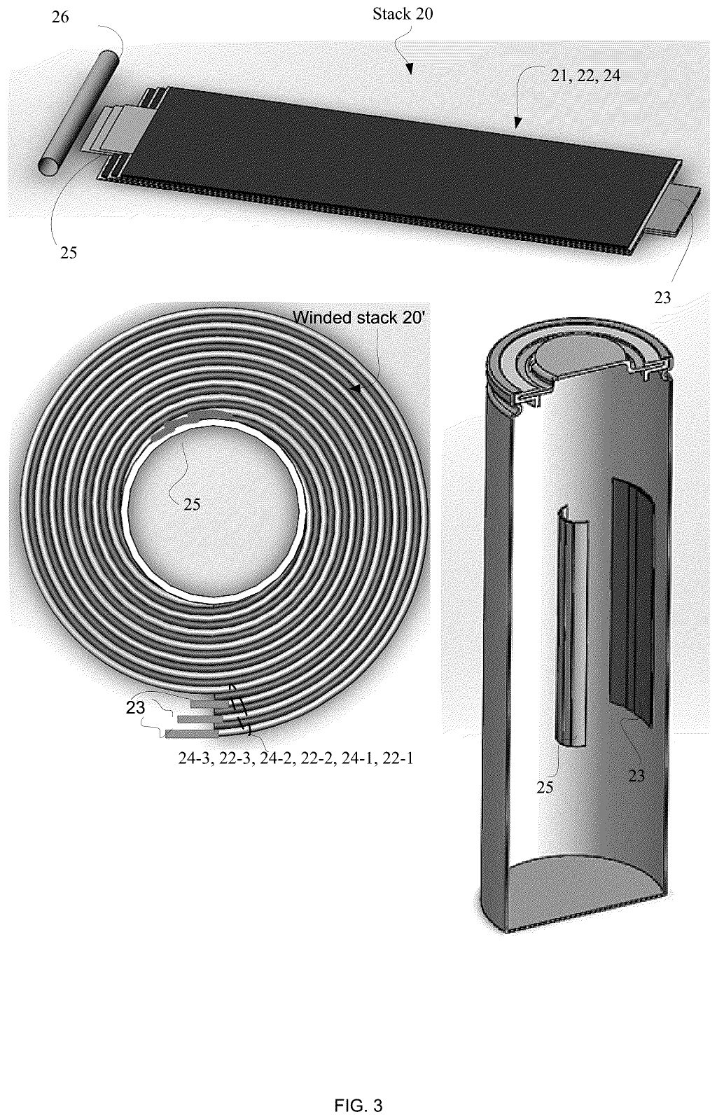

According to an embodiment—the first side of the stack is a top side of the stack and the second side of the stack is a bottom side of the stack. This is illustrated in FIG. 3.

The electrochemical wherein the multiple anode tabs are positioned at a first longitudinal coordinates range (for example x-axis coordinate of FIG. 3), wherein the multiple cathode tabs are positioned at a second longitudinal coordinates range. The first longitudinal coordinates range and the second longitudinal coordinates range may not overlap at all (see FIG. 3), may partially overlap or may fully overlap.

According to an embodiment—the first side of the stack is a right side of the stack (when the stack is unwinded) and the second side of the stack is a left side of the stack- or vice-verse.

At least some of the tabs of the instances may be aligned, once winded.

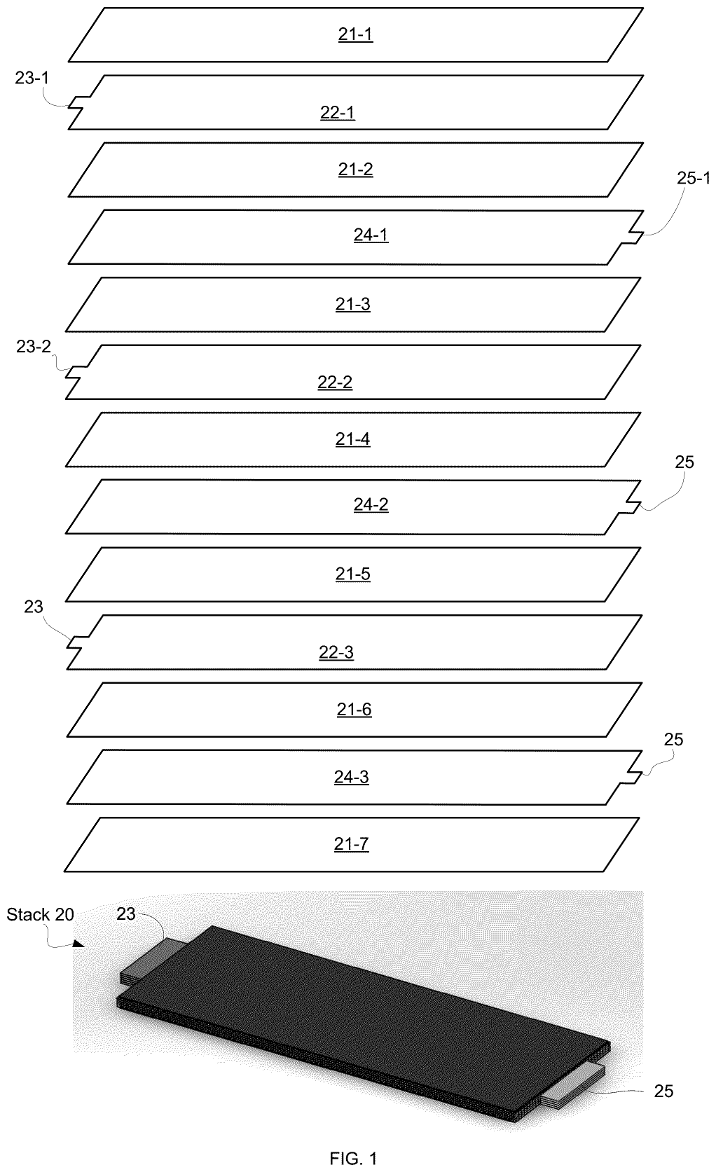

FIG. 1 illustrates an exploded view and an isometric view of stack 20.

The exploded view illustrates a stack that includes (from top to bottom) first separator 21-1, first anode 22-1 with first anode tab 23-1, second separator 21-2, first cathode 24-1 with first cathode tab 25-1, third separator 21-3, second anode 22-2 with second anode tab 23-2, fourth separator 21-4, second cathode 24-1 with second cathode tab 25-2, fifth separator 21-5, third anode 22-3 with third anode tab 23-3, sixth separator 21-6, third cathode 24-3 with third cathode tab 25-3, and seventh separator 21-7.

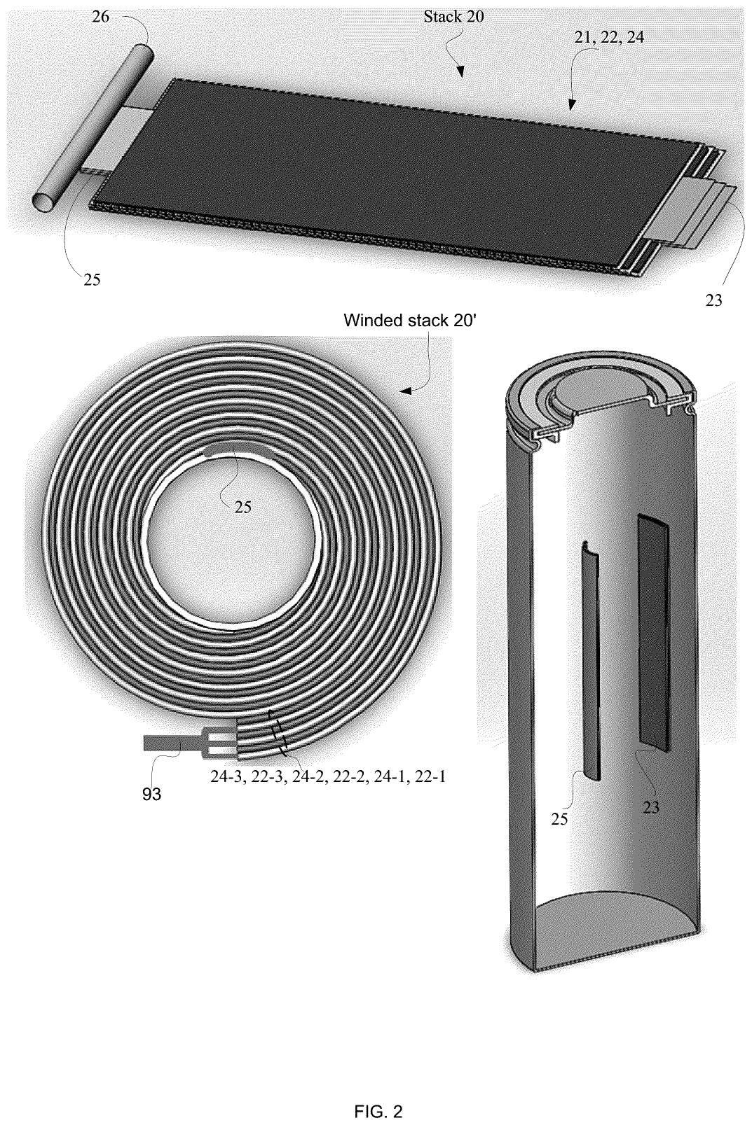

Each one of FIGS. 2, 3, 4, 5, 6 and 7 illustrates an example of a stack (top part of the figure), a winded stack (bottom left part of the figure) and a cross sectional view (bottom right part of the figure) of a cylindrical cell that shows the housing of the cell, the anode tabs and the cathode tabs within the housing—other parts of the cell within the housing are not shown for simplicity of explanation.

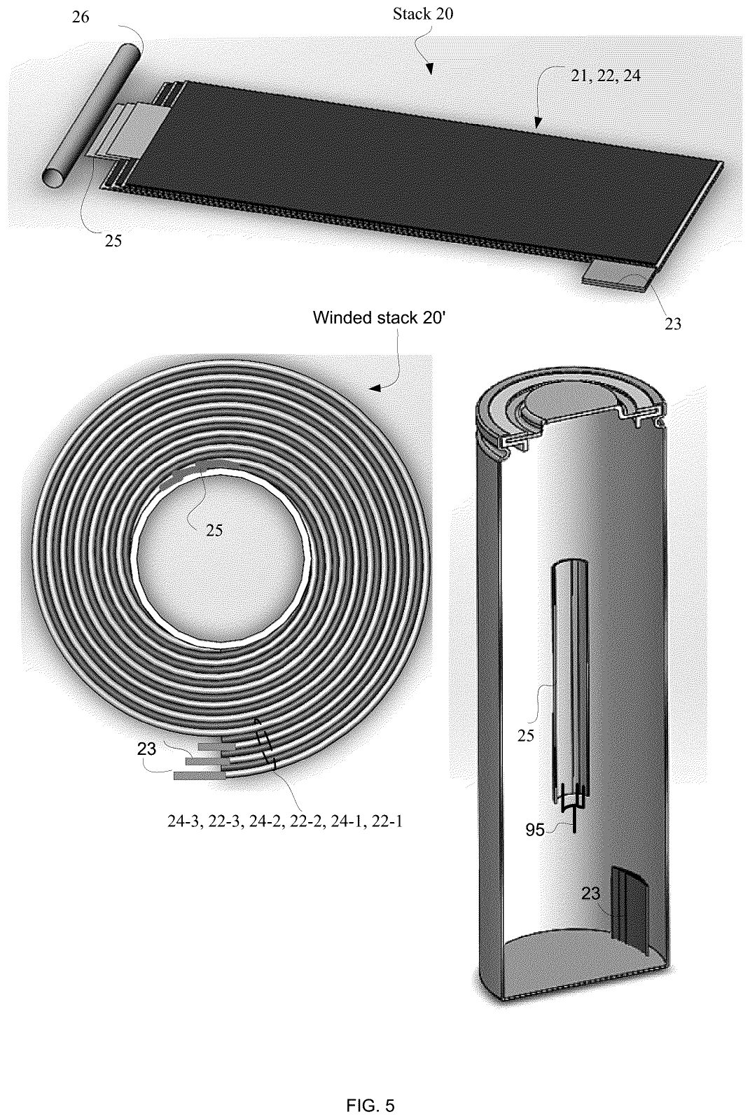

For simplicity of explanation the cathode tabs electrical coupler 93 is illustrated only in FIG. 2 and the anode tabs electrical coupler 95 is illustrated only in FIG. 5. It should be noted that in any of the examples the cathode tabs are electrically coupled to each other in parallel and/or the anode tabs are electrically coupled to each other in parallel.

FIG. 2 illustrates stacked electrodes with opposite tabs located at the left and the right of the stacked electrodes and do not extend from the top or the bottom of the stack. Before winding—the cathode tabs are aligned. After winding the cathode tabs are aligned and the anode tabs are aligned.

FIG. 3 illustrates stacked electrodes with opposite tabs located at the left and the right of the stacked electrodes and do not extend from the top or the bottom of the stack. Before winding—the anode tabs are aligned. After winding the cathode tabs partially overlap and the anode tabs partially overlap.

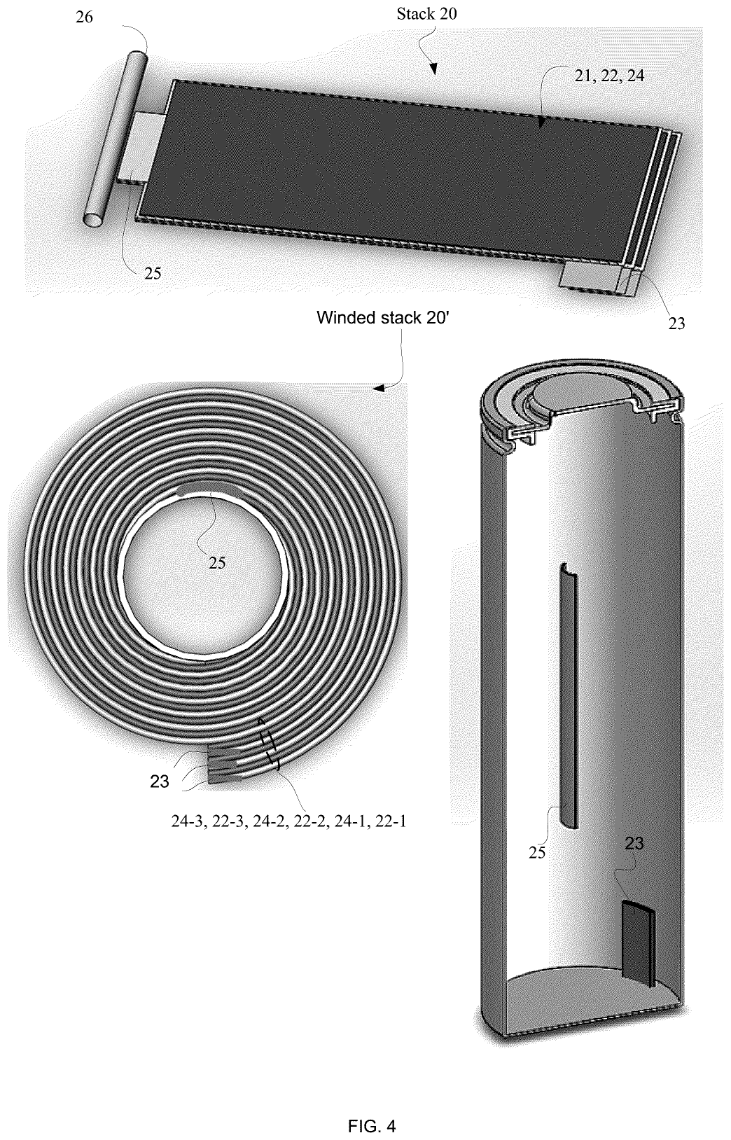

FIG. 4 illustrates stacked electrodes with cathode tabs located at the left of the stacked electrodes and the anode tabs located at the right part of the bottom of the stacked electrodes. Before winding—the anode tabs are aligned. After winding the cathode tabs are aligned and the anode tabs are aligned.

FIG. 5 illustrates stacked electrodes with cathode tabs located at the left of the stacked electrodes and the anode tabs located at the right part of the bottom of the stacked electrodes. Before winding—the cathode tabs are aligned. After winding the cathode tabs partially overlap and the anode tabs partially overlap.

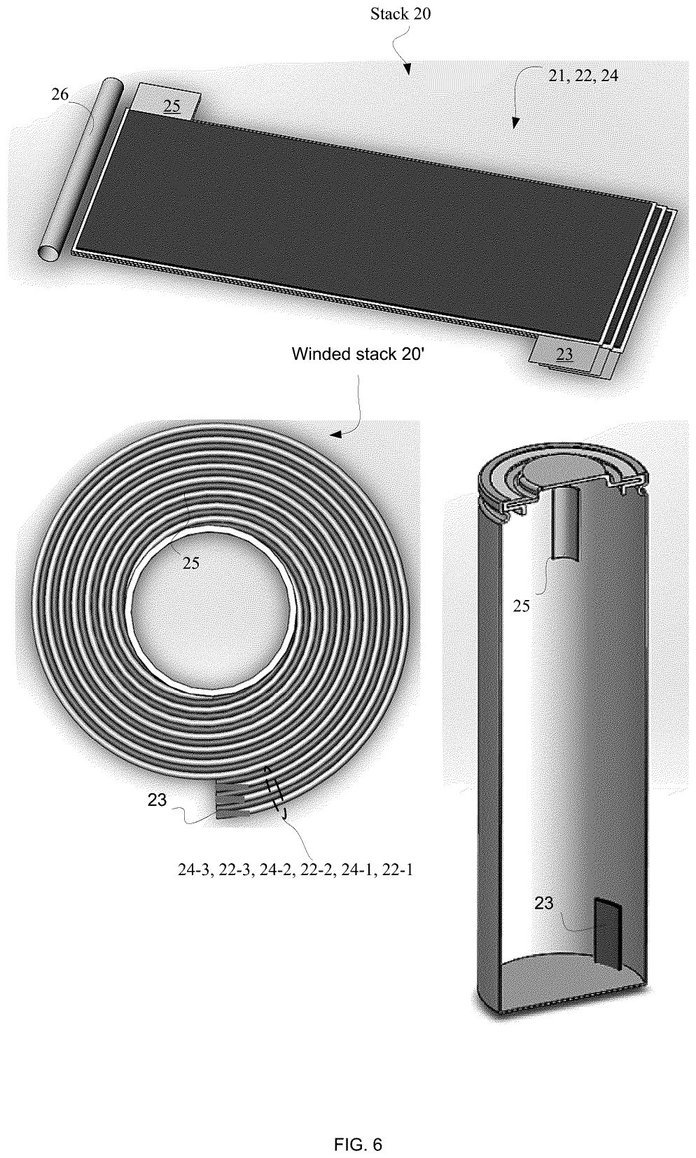

FIG. 6 illustrates stacked electrodes with cathode tabs located at the left part of the top of the stacked electrodes and the anode tabs located at the right part of the bottom of the stacked electrodes. Before winding—the anode tabs are aligned. After winding the cathode tabs are aligned and the anode tabs are aligned.

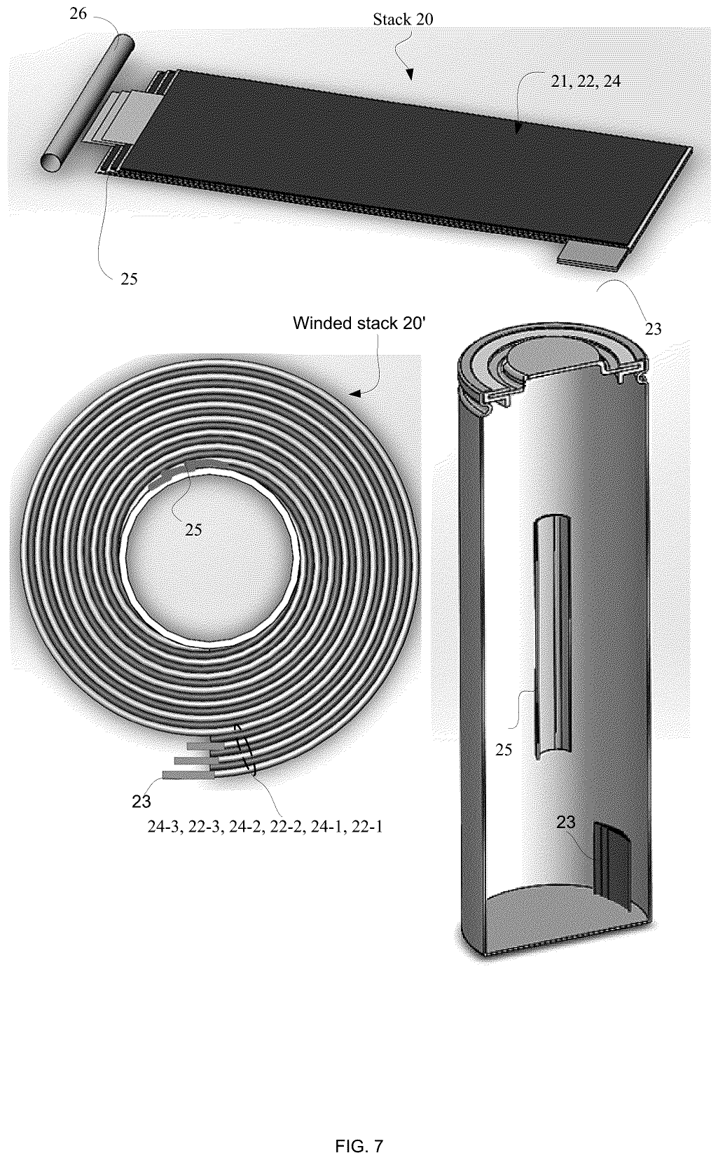

FIG. 7 illustrates stacked electrodes with cathode tabs located at the left part of the top of the stacked electrodes and the anode tabs located at the right part of the bottom of the stacked electrodes. Before winding—the anode tabs are aligned. After winding the cathode tabs partially overlap and the anode tabs partially overlap.

The electrochemical wherein the multiple instances may include at least two instances.

In FIGS. 2-7 each winding includes three instances of anodes and cathodes-first anode 22-1, first cathode 24-1, second anode 22-2, second cathode 24-2, third anode 22-3 and third cathode. For simplicity of explanation the separators are not shown.

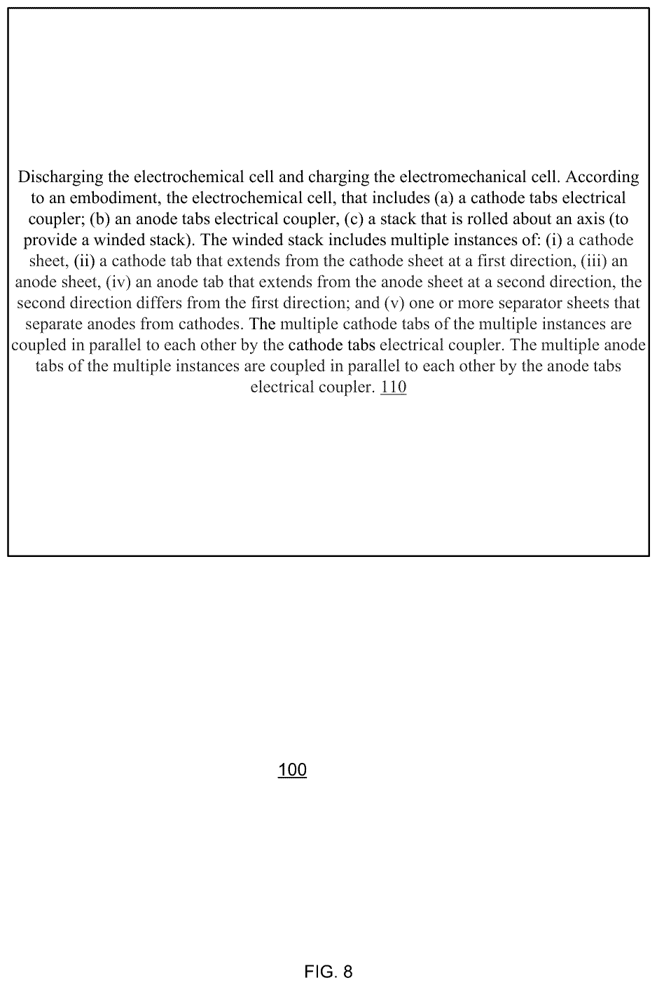

FIG. 8 illustrates a method 100 for operating an electrochemical cell.

Method 100 may include step 110 of discharging the electrochemical cell and charging the electromechanical cell. According to an embodiment, the electrochemical cell, that includes (a) a cathode tabs electrical coupler; (b) an anode tabs electrical coupler, (c) a stack that is rolled about an axis (to provide a winded stack). The winded stack includes multiple instances of: (i) a cathode sheet, (ii) a cathode tab that extends from the cathode sheet at a first direction, (iii) an anode sheet, (iv) an anode tab that extends from the anode sheet at a second direction, the second direction differs from the first direction; and (v) one or more separator sheets that separate anodes from cathodes. The multiple cathode tabs of the multiple instances are coupled in parallel to each other by the cathode tabs electrical coupler. The multiple anode tabs of the multiple instances are coupled in parallel to each other by the anode tabs electrical coupler.

According to an embodiment—the multiple cathode tabs are aligned.

According to an embodiment—the multiple anode tabs are aligned.

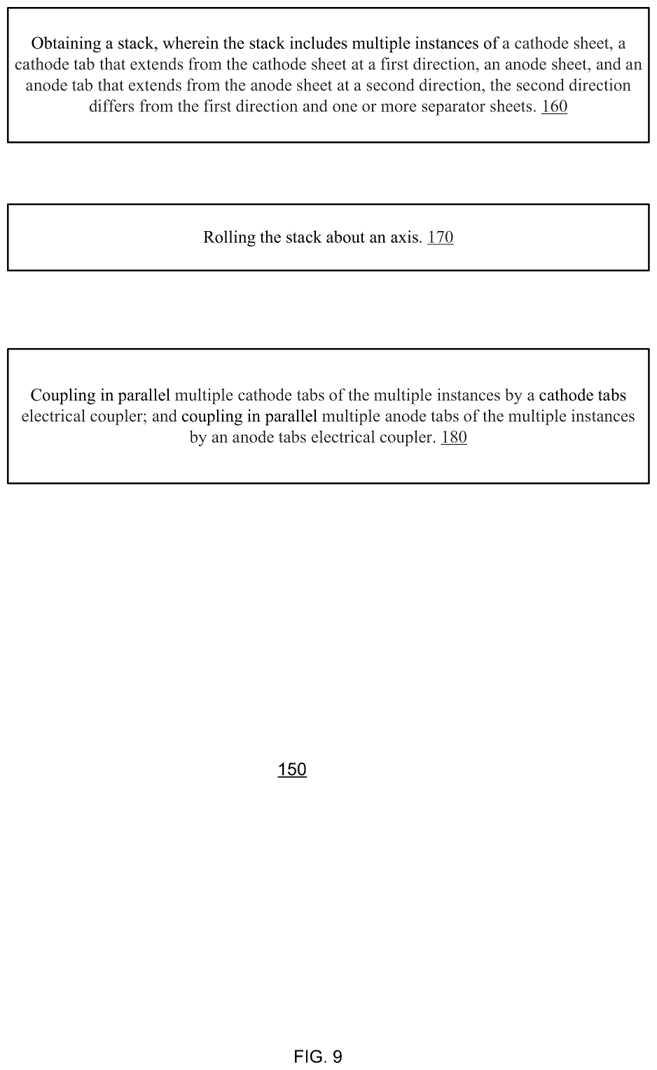

FIG. 9 illustrates an example of a method 150 for manufacturing a electrochemical cell.

Method 150 starts by step 160 of obtaining a stack, wherein the stack includes multiple instances of a cathode sheet, a cathode tab that extends from the cathode sheet at a first direction, an anode sheet, and an anode tab that extends from the anode sheet at a second direction, the second direction differs from the first direction and one or more separator sheets.

Step 160 is followed by step 170 of rolling the stack about an axis.

Step 170 may be followed by step 180 of coupling in parallel multiple cathode tabs of the multiple instances by a cathode tabs electrical coupler; and coupling in parallel multiple anode tabs of the multiple instances by an anode tabs electrical coupler.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected.” or “operably coupled,” to each other to achieve the desired functionality.

Any reference to “consisting”, “having” and/or “including” should be applied mutatis mutandis to “consisting” and/or “consisting essentially of”.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first”, “second”. “third” and “fourth” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

What is claimed is:

1. A electrochemical cell, comprising:
a cathode tabs electrical coupler;
an anode tabs electrical coupler; and
a stack that is rolled about an axis, wherein the stack comprises multiple instances of:
a cathode sheet;
a cathode tab that extends from the cathode sheet at a first direction;
an anode sheet,
an anode tab that extends from the anode sheet at a second direction, the second direction differs from the first direction; and
one or more separator sheets;
wherein multiple cathode tabs of the multiple instances are coupled in parallel to each other by the cathode tabs electrical coupler; and
wherein multiple anode tabs of the multiple instances are coupled in parallel to each other by the anode tabs electrical coupler.

2. The electrochemical according to claim 1, wherein the multiple cathode tabs of the stack are aligned.

3. The electrochemical according to claim 2, wherein the multiple anode tabs of the stack are aligned.

4. The electrochemical according to claim 3, wherein the multiple anode tabs extend from a first side of the stack and the multiple cathode tabs extend from a second side of the stack.

5. The electrochemical according to claim 4, wherein the first side of the stack is a top side of the stack and wherein the second side of the stack is a bottom side of the stack.

6. The electrochemical according to claim 5, wherein the multiple anode tabs are positioned at a first longitudinal coordinates range, wherein the multiple cathode tabs are positioned at a second longitudinal coordinates range.

7. The electrochemical according to claim 6, wherein the first longitudinal coordinates range and the second longitudinal coordinates range at least partially overlap.

8. The electrochemical according to claim 1, wherein the multiple instances comprise at least two instances.

9. The electrochemical according to claim 1, wherein the cathode tabs of the multiple instances or the anode tabs of the multiple instances are aligned, once winded.

10. The electrochemical according to claim 1, wherein the cathode tabs of the multiple instances or the anode tabs of the multiple instances are misaligned, once winded.

11. The electrochemical according to claim 1, wherein the cathode tabs of the multiple instances or the anode tabs of the multiple instances partially overlap, once winded.

12. A method for operating an electrochemical cell, the method comprises: discharging the electrochemical cell and charging the electromechanical cell, wherein the electromechanical cell comprises:
a stack that is rolled about an axis, wherein the stack comprises:
a cathode tabs electrical coupler;
an anode tabs electrical coupler; and
multiple instances of:
a cathode sheet;
a cathode tab that extends from the cathode sheet at a first direction;
an anode sheet, and
an anode tab that extends from the anode sheet at a second direction, the second direction differs from the first direction and one or more separator sheets;
wherein multiple cathode tabs of the multiple instances are coupled in parallel to each other by the cathode tabs electrical coupler; and
wherein multiple anode tabs of the multiple instances are coupled in parallel to each other by the anode tabs electrical coupler.

13. A method for manufacturing a electrochemical cell, the method comprises:
obtaining a stack, wherein the stack comprises: multiple instances of a cathode sheet, a cathode tab that extends from the cathode sheet at a first direction, an anode sheet, and an anode tab that extends from the anode sheet at a second direction, the second direction differs from the first direction and one or more separator sheets; and
rolling the stack about an axis.

14. The method according to claim 11, comprising:
coupling in parallel multiple cathode tabs of the multiple instances by a cathode tabs electrical coupler; and
coupling in parallel multiple anode tabs of the multiple instances by an anode tabs electrical coupler.
